(19) United States
(12) Patent Application Publication
(10) Pub. No.: US 2026/0003634 A1
(43) Pub. Date: Jan. 1, 2026

(54) AUTOMATIC DATA ROUTING MODULE FOR AN SIMD ARCHITECTURE COMPUTER

(71) Applicant: COMMISSARIAT A L’ENERGIE ATOMIQUE ET AUX ENERGIES ALTERNATIVES, PARIS (FR)

(72) Inventor: Raphael MILLET, GIF-SUR-YVETTE (FR)

(21) Appl. No.: 19/235,344

(22) Filed: Jun. 11, 2025

(30) Foreign Application Priority Data
Jun. 28, 2024 (FR) 2407032

(51) Int. Cl. G06F 9/38; G06F 15/80

(52) U.S. Cl. CPC G06F 9/3887; G06F 15/8007

(57) ABSTRACT

An automatic data routing module for a “single instruction, multiple data” architecture computer includes a plurality of elementary processors each associated with a local memory, the routing module including: an input interface including a plurality of input buffers, each intended to receive data read from a respective local memory; an output interface including a plurality of output buffers, each intended to transmit data to be written to a respective local memory; a selector, for each input buffer, configured to select one or more data items contained in the input buffer; at least one assembler configured to consolidate the data selected by at least two selectors into an assembly buffer; a transfer module for each assembler, configured to transfer the data from the assembly buffer of said assembler to at least one output buffer for writing said data to at least one local memory.

### CROSS-REFERENCE TO RELATED APPLICATION

This application claims priority to foreign French patent application No. FR 2407032, filed on Jun. 28, 2024, the disclosure of which is incorporated by reference in its entirety.

### FIELD OF THE INVENTION

The invention relates to the field of SIMD (Single Instruction, Multiple Data) architecture computers, for example computers intended to implement artificial intelligence algorithms such as deep neural networks, image processing algorithms or, more generally, computers designed to implement computations on very large amounts of data.

More specifically, the invention relates to an automatic data routing module configured to reliably and quickly move data in local memories in order to meet the computing requirements applied to large amounts of data.

### BACKGROUND

SIMD architecture computers are notably used to produce deep neural networks or image processing devices. For this type of application, the issue of data movement is highly important. Deep neural networks are machine learning models that require a considerable amount of data in order to perform complex tasks such as image recognition, object detection or anomaly detection.

Data movement refers to the manipulation and the transfer of this data from one memory location to another. This raises a number of challenges within the context of deep neural networks. The massive amount of data used by these models requires adequate storage and processing resources in order to efficiently manage the movement operations. The data must be quickly and reliably transferred in order to minimize latency and optimize neural network performance capabilities.

Furthermore, deep neural networks incorporate a wide variety of operations. These require different data distributions. Within this context, rearranging data in short-term computation memories may be necessary. Without dedicated hardware, this type of operation can significantly degrade the overall performance capabilities (execution time and energy consumption).

For these reasons, a requirement exists for an automatic data routing mechanism that is fast, scalable and adaptable according to the target application. In general, such a routing module is necessary for managing data movements for any type of computer implementing operations applied to large amounts of data, notably convolution operations such as those implemented by deep neural networks.

European patent EP 3335107 describes a computing device for image processing applications. The device is capable of rearranging video data in order to have contiguous pixels. To this end, it uses additional buffer memories connected to the data stream arriving from a sensor (camera).

This solution only supports one type of contiguous pixel reordering. In addition, buffer memories are required. Thus, this solution is not optimal in terms of memory usage and is neither scalable nor modular.

U.S. Pat. No. 6,735,647 describes a device and a method for spontaneously rearranging data in a communication network. In this case, this involves communications between remote units and the manipulation of data in the frames that convey the data.

This solution involves only one data source and only covers transfers via network frames. It is therefore not applicable to computers implementing a deep neural network. It is neither scalable nor modular.

FIG. 1a shows an architecture of a computing system based on a hardware accelerator according to the prior art.

Such a system comprises a host processor PROC, a hardware accelerator ACC, a level 2 global memory MEM2 and an interconnection bus BUS.

The host processor PROC is a central processing unit that manages the general execution of the system, including communication with the hardware accelerator ACC.

The hardware accelerator ACC is specifically designed to accelerate specific types of computations such as machine learning operations or intensive computations. It comprises a global controller CTRL and a set of computing blocks BCN (for example, neural computations). Each computing block BCN comprises a level 1 memory BMEM and a set of computing units PE. The level 1 memory BMEM is typically divided into at least one source memory block and at least one destination memory block for managing data rearrangement in a memory during computations.

The level 2 memory MEM2 corresponds to the main memory of the embedded system.

The interconnection bus BUS allows communication between the central host processor PROC, the hardware accelerator ACC and the level 2 memory MEM2.

FIG. 1b shows an example of data rearrangement in a memory involving transitioning from a first memory location 101 with 2-step data interleaving to a second memory location 102 with 16-step data interleaving.

In order to accelerate the computation, the location of the data in a memory must meet certain constraints in order to achieve the best performance capabilities. The specific data access capabilities and features of the accelerator ACC (for example, access to neighbouring BCNs) and the distribution of data related to the operation must be taken into account when locating data in a memory.

Furthermore, this location of data in a memory may need to be modified when executing a complete application. Indeed, this involves applying various constraints in terms of operations and the associated data distribution.

When the accelerator ACC does not have a dedicated function for this type of processing, the host processor PROC must read the data from the computing blocks BCN and perform a set of data manipulations before transferring said data to the computing blocks BCN with the new data arrangement. This processing involves executing a complex routine that is particularly costly in terms of latency and energy. Furthermore, it involves transferring data to the level 2 memory, which interrupts the parallelism of the computations and induces additional latency.

### SUMMARY OF THE INVENTION

The invention proposes integrating an automatic data routing module into the hardware accelerator ACC in order to automatically perform data location and rearrangement operations, irrespective of the target application. The proposed solution is compatible with SIMD computing architectures incorporating distributed memories and is scalable and modular. It also induces low processing latency.

The aim of the invention is an automatic data routing module for a “single instruction, multiple data” architecture computer comprising a plurality of elementary processors each associated with a local memory, the routing module comprising:
an input interface comprising a plurality of input buffers, each intended to receive data read from a respective local memory;
an output interface comprising a plurality of output buffers, each intended to transmit data to be written to a respective local memory;
a selector, for each input buffer, configured to select one or more data items contained in the input buffer;
at least one assembler configured to consolidate the data selected by at least two selectors into an assembly buffer;
a transfer module for each assembler, configured to transfer the data from the assembly buffer of said assembler to at least one output buffer for writing said data to at least one local memory.

In an alternative embodiment, the routing module according to the invention further comprises a control unit comprising at least three identical controllers respectively configured to control all the selectors, an assembler and a transfer module, each controller being configured to generate a control signal based on a set of specific configuration signals.

According to a particular aspect of the invention, a controller comprises at least one counter and a shift unit configured, based on the set of configuration signals, to generate a control signal.

According to a particular aspect of the invention, the set of configuration signals comprises: an initial value of the control signal, a counting length value, a loopback value and a shift value, the value of the control signal being shifted by the shift value when the counter reaches the counting length value, the value of the control signal being reset to its initial value when it reaches the loopback value.

According to a particular aspect of the invention, the set of configuration signals includes a shift activation value for activating or deactivating the shift of the control signal.

According to a particular aspect of the invention, the shift of the control signal of the transfer module is deactivated.

According to a particular aspect of the invention, the control signal of the set of selectors is configured to notify each selector of which data to select from the input buffer from among a plurality of concatenated data.

According to a particular aspect of the invention, the control signal of the assembler is configured to notify the assembler of which selectors to select as inputs.

According to a particular aspect of the invention, the control signal of the transfer module is configured to notify the transfer module of the output buffer to which the data from the assembly buffer is to be transferred.

According to a particular aspect of the invention, the values of the configuration signals are defined such that the routing module is configured to receive data read from the local memories in interleaved form according to a first interleaving configuration, the input buffers being designed to receive a concatenation of a plurality of data from a row in a local memory.

According to a particular aspect of the invention, the values of the configuration signals are defined such that the routing module is configured to supply, in the output buffers, data intended to be written to the local memories in interleaved form according to a second interleaving configuration different from the first interleaving configuration.

In an alternative embodiment, the routing module according to the invention comprises a plurality of assemblers and a plurality of transfer modules and a decision-making unit for managing the transfer priorities of the outputs of the transfer modules to the output buffers.

A further aim of the invention is a “single instruction, multiple data” architecture computer comprising a host processor and a hardware accelerator comprising a plurality of computing blocks, each computing block comprising a local memory and at least one elementary processor, a global controller and an automatic data routing module according to the invention configured to modify the location of data in the local memories according to a location instruction generated by the global controller, the global controller being configured to define the configuration signals of the control unit of the automatic routing module based on the location instruction.

According to an alternative embodiment, the computer according to the invention further comprises an address generator configured to generate a read address in the local memories for reading the data to be transferred to the automatic routing module and a write address in the local memories for writing the data supplied by the automatic routing module.

### BRIEF DESCRIPTION OF THE DRAWINGS

Further features and advantages of the present invention will become more clearly apparent from the following description with reference to the accompanying drawings.

FIG. 1a shows an architecture of a computer comprising a parallel computing accelerator according to the prior art.

FIG. 1b shows an example of data rearrangement in a memory from 2-step interleaving to 16-step interleaving.

FIG. 2 shows an architecture of a computer comprising an automatic routing module according to one embodiment of the invention.

FIG. 3 shows an architecture of a data arranger according to one embodiment of the invention.

FIG. 4 shows an architecture of a multi-transfer module according to one embodiment of the invention.

FIG. 5 shows an architecture of a control and shift unit according to one embodiment of the invention.

FIG. 6a illustrates an application of the invention for rearranging data from 2-step memory interleaving to 16-step memory interleaving.

FIG. 6b illustrates an example of rearranging data in a memory from 2-step interleaving to 16-step interleaving.

FIG. 7 illustrates the configuration of the automatic routing module for rearranging data illustrated in FIG. 6b.

FIG. 8 illustrates the generation of the first output buffer.

FIG. 9 illustrates the generation of the second output buffer.

FIG. 10 illustrates the generation of the third output buffer.

FIG. 11 illustrates the generation of the fourth output buffer.

FIG. 12a illustrates an application of the invention for rearranging data from 2-step memory interleaving to 4-step memory interleaving.

FIG. 12b illustrates an example of rearranging data in a memory from 2-step interleaving to 4-step interleaving.

FIG. 13 illustrates the configuration of the automatic routing module for rearranging data as shown in FIG. 12b.

FIG. 14 illustrates the generation of the first output buffer for the application shown in FIG. 12a.

FIG. 15 illustrates the generation of the second output buffer for the application shown in FIG. 12a.

FIG. 16a illustrates another example of the configuration of the automatic routing module according to another embodiment of the invention.

FIG. 16b illustrates an example of rearranging data in a memory from 2-step interleaving to 8-step interleaving.

### DETAILED DESCRIPTION

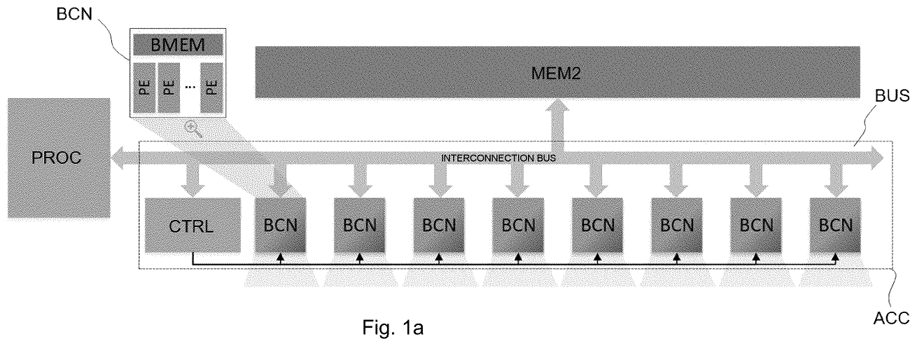

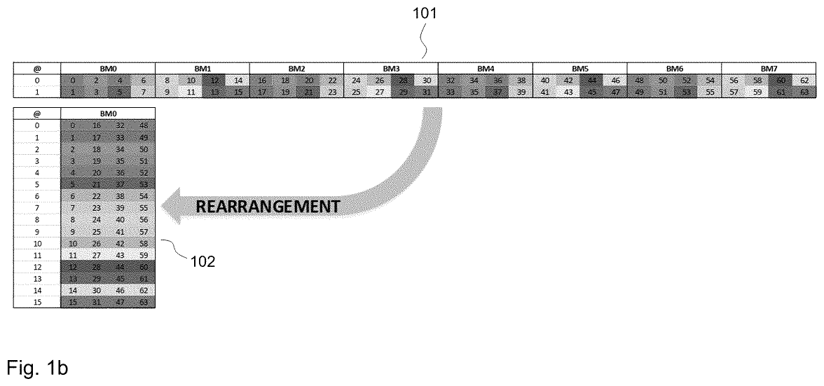

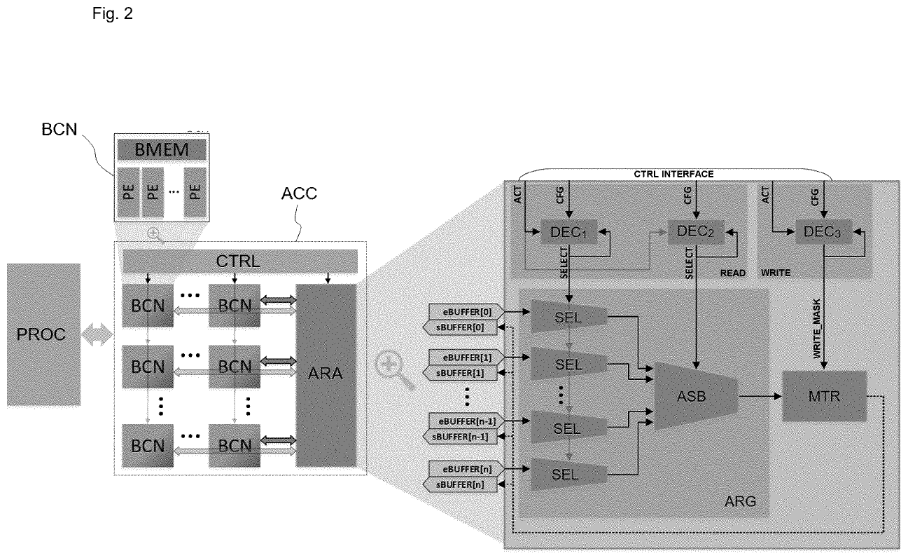

FIG. 2 shows a diagram of an architecture of a computer comprising an automatic routing module according to one embodiment of the invention. The computer in FIG. 2, like that in FIG. 1b, comprises a host processor PROC and a hardware accelerator ACC comprising a global controller CTRL, a plurality of computing blocks BCN each comprising a memory block BMEM and a plurality of computing units PE, as well as an automatic routing module ARA according to the invention.

The automatic routing module ARA is configured for advanced routing of N sources to M destinations with spontaneous automatic rearrangement of data. This device is suitable for SIMD (Single Instruction, Multiple Data) computing architectures incorporating distributed memories.

The computing blocks BCN comprise memories BMEM that are connected to the automatic routing module ARA.

Each memory block BMEM comprises at least one read-accessible source memory and one write-accessible destination memory.

The automatic routing module ARA comprises an input interface that includes as many input buffers as there are source memories and an output interface that includes as many output buffers as there are destination memories.

Useful data originating from or intended for the memories is encapsulated in the input (eBUFFER) or output (sBUFFER) buffers according to a given assembly. For example, a buffer with a width of 32 bits encapsulates 4 items of 8-bit data. More generally, a buffer encapsulates several items of data of the same size.

The automatic routing module ARA comprises as many selectors SEL as input buffers and output buffers, an assembler ASB, a multi-transfer module MTR and three control and shift units DEC₁, DEC₂, DEC₃ that are identical in terms of hardware but are independently configurable.

The selectors SEL implement the first routing level, responsible for selecting one or more data items from each input buffer. All the selectors SEL are connected at the output to the input of the assembler ASB responsible for forming the destination buffer. Finally, the multi-transfer module MTR allows the destination buffer to be written to one or more memories via the output buffers.

Each of the aforementioned sub-modules has a control and shift unit DEC₁, DEC₂, DEC₃, which is configured and synchronized by the global controller CTRL of the hardware accelerator ACC via configuration CFG and activation ACT signals. In other words, the global controller CTRL manages the activation of the routing module and its configuration. Once configured, routing is spontaneously performed automatically. The configuration signals CFG depend on the target application and the specific routing function to be implemented. The control signals output from the control and shift units DEC₁, DEC₂ and DEC₃ are used to control the respective operation of the selectors SEL, the assembler ASB and the multi-transfer module MTR.

This routing device ARA allows data to be spontaneously rearranged in an efficient, automated manner, with the ability to produce an output buffer for each cycle. It is also a scalable and modular device that can be adapted to the size of the memory buffers, the useful data and the number of connected computing blocks.

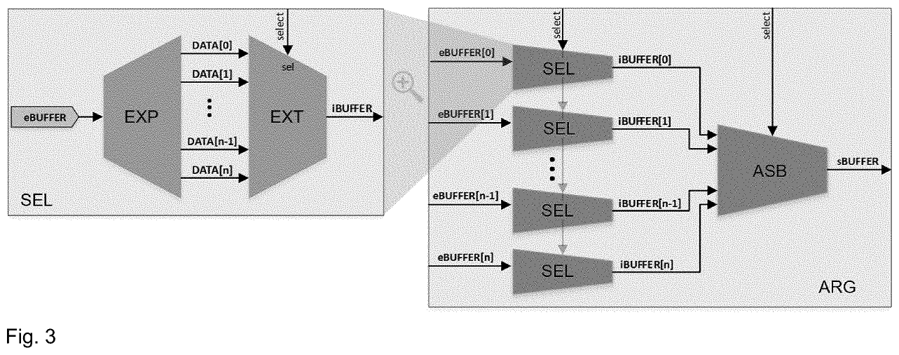

FIG. 3 shows an embodiment of the data arranger module ARG according to the invention, which comprises a plurality of data selectors SEL and an assembler ASB.

The arranger module ARG comprises as many selectors SEL as input buffers eBUFFER. Each selector SEL is controlled by the same selection signal delivered by the control unit DEC₁, which notifies it concerning which data to read from the input buffer, which contains several encapsulated data items. The size of the selection signal is, for example, equal to the number of data items encapsulated in a buffer.

The selected data item is placed in an intermediate buffer iBUFFER supplied to the assembler ASB as input.

The assembler ASB is controlled by a selection signal delivered by the control unit DEC₂, which notifies it concerning which intermediate buffers associated with which selectors it must select in order to concatenate the data from the selected intermediate buffers into an output buffer sBUFFER.

The size of the selection signal for the assembler ASB is, for example, equal to the number of selectors SEL.

Each selector SEL comprises a demultiplexer EXP configured to demultiplex the data concatenated in the input buffer eBUFFER and a multiplexer EXT controlled by the select selection signal, which selects the data to be supplied to the intermediate buffer iBUFFER.

The arranger module ARG is scalable and can be adapted to the desired number of external connections. For each external connection, a selector SEL must be instantiated and an additional input must be provided for the assembler ASB.

The selector SEL is scalable in that the size of the input buffer eBUFFER and the number of data items it encapsulates, as well as their resolution, are configurable. For example, the selector SEL can be configured for a 32-bit input buffer containing 4 data items with a resolution of 8 bits.

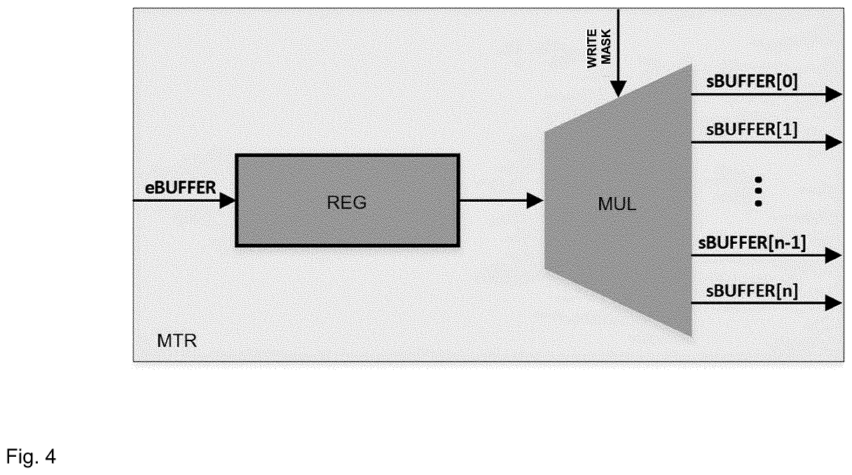

FIG. 4 shows an embodiment of the multi-transfer module MTR. This module includes a register REG for storing data originating from the arranger module ARG. The register output is simultaneously switched to the output buffers of the routing module, as defined by a control signal in the form of a write mask that is generated by the control unit DEC₃. The number of associated outputs and the size of the associated write mask are scalable according to the number of connected computing blocks BCN. As with the other modules, the size of the buffers is also scalable according to the requirements of the associated architecture.

The size of the write mask signal depends on the number Nb of BCN of connected computing blocks BCN.

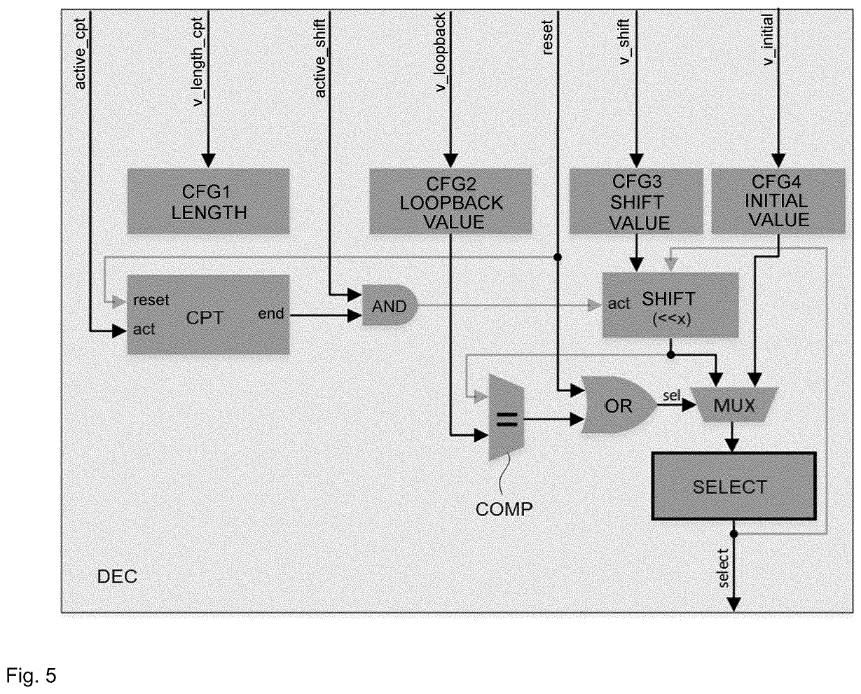

FIG. 5 shows an embodiment of a control and shift unit DEC. The three control and shift units included in the automatic routing module have the same architecture but are configured via a set of configuration signals specific to each unit.

The control and shift unit DEC includes a counter CPT that is configured to generate a shift via the register DECAL according to a delay defined by the length of the counter. Counting is triggered via the signal active_cpt produced by the global controller CTRL each time the automatic routing module ARA is accessed. The shift is notably performed via a comparator COMP associated with a loopback value, which, once reached, forces a return to the initial value.

The collaboration between the counter and the shift register allows the control of the various data routing elements to be automated.

More specifically, the output signal from the counter CPT is supplied as input for an AND logic gate, which receives the shift activation signal on its other input. If the shift is activated, the output signal from the counter CPT is propagated as output from the AND gate to the shift register DECAL, which shifts the value contained in this register by a number of bits equal to the shift value contained in the configuration register CFG3.

A comparator COMP compares the value of the shift register DECAL with the loopback value stored in the configuration register CFG2. The output of the comparator COMP and a reset signal RAZ are supplied as input for an OR gate. The output of the OR gate is a selection signal that controls a multiplexer MUX. The multiplexer MUX receives the value of the shift register DECAL and the initial value stored in the configuration register CFG4 as input. This mechanism allows the multiplexer MUX to select the initial value when the value of the shift register reaches the loopback value. Otherwise, the value of the shift register is supplied to the selection register SELECT. The output of this register is fed back to the shift register DECAL for the next shift operation.

Without departing from the scope of the invention, other implementations can be contemplated for implementing the initial value shift function as explained above.

The configuration signals include the following signals.

The signal v_length_cpt stored in the configuration register CFG1 provides the counting length of the counter CPT that triggers the shift, via the register DECAL, of the initial value stored in the configuration register CFG4 if it is activated via the activation signal active_shift.

The signal active_shift allows the shift to be activated, which can be deactivated. In this case, the “select” output signal remains constant.

The signal v_loopback provides a loopback value that corresponds to the limit value before returning to the initial value.

The reset signal triggers the counter to be reset to zero and forces the register SELECT to the initial value.

The signal v_shift provides the shift value of the selection signal, which is stored in the configuration register CFG3.

The signal v_initial provides the initial value loaded into the register SELECT during a reset or loopback.

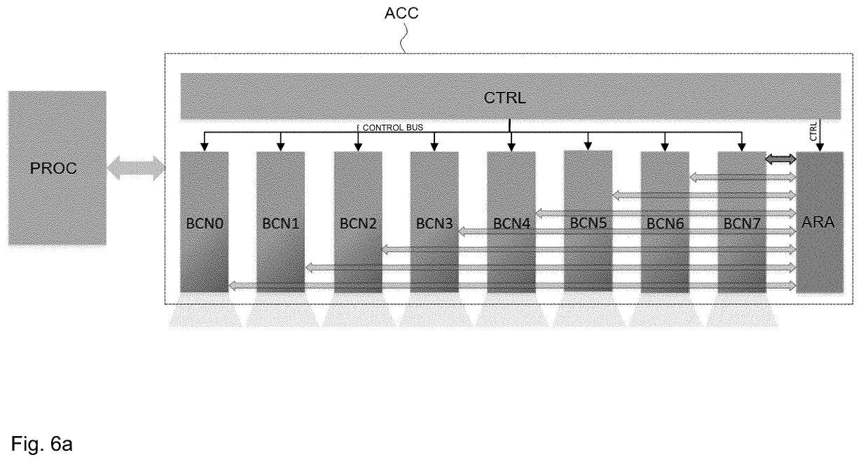

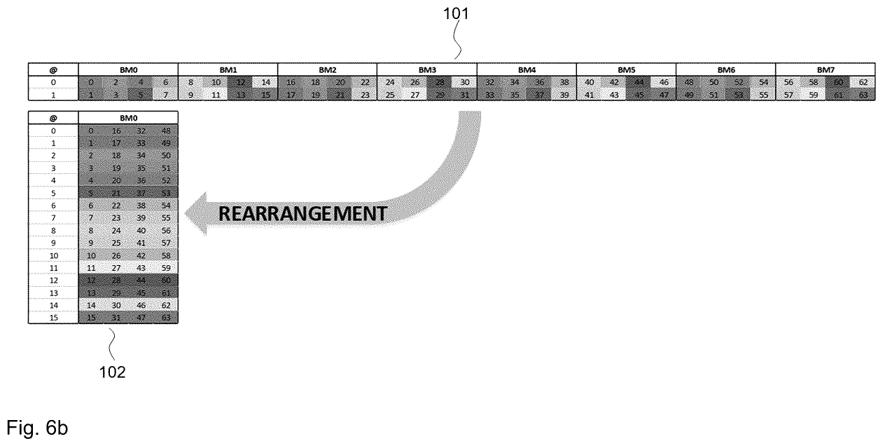

An embodiment of the automatic routing module ARA according to the invention for rearranging data in the memory blocks of the computing blocks BCN will now be described with reference to FIGS. 6a and 6b. In this example, the data is arranged in the source memories of the computing blocks BCN with 2-step interleaving. The data is to be rearranged in the destination memories with 16-step interleaving for specific computation requirements.

Data storage with interleaving is a well-known principle in image processing. It involves placing data (corresponding, for example, to pixels) in columns. The interleaving value corresponds to the numbers of pixels placed in a column.

In the example in FIG. 6a, the hardware accelerator ACC comprises 8 computing blocks connected to the routing device ARA. The size of the input buffers is 32 bits, while the data is encoded on 8 bits. Each input buffer therefore comprises 4 items of 8-bit data.

The original data location is a set 101 of 64 pixels distributed across the 8 memories of the computing blocks BCN with 2-step interleaving. The desired data rearrangement involves interleaving 102 16 pixels in the first computing block BCN0.

Each memory in a computing block is organized in the form of 32-bit rows that can contain 4 items of 8-bit data. Each row has an address.

FIG. 6b shows the memory location of the 64 pixels via the pixel number (ranging from 0 to 63) in the corresponding memory location of the source memories 101 and of the destination memory 102.

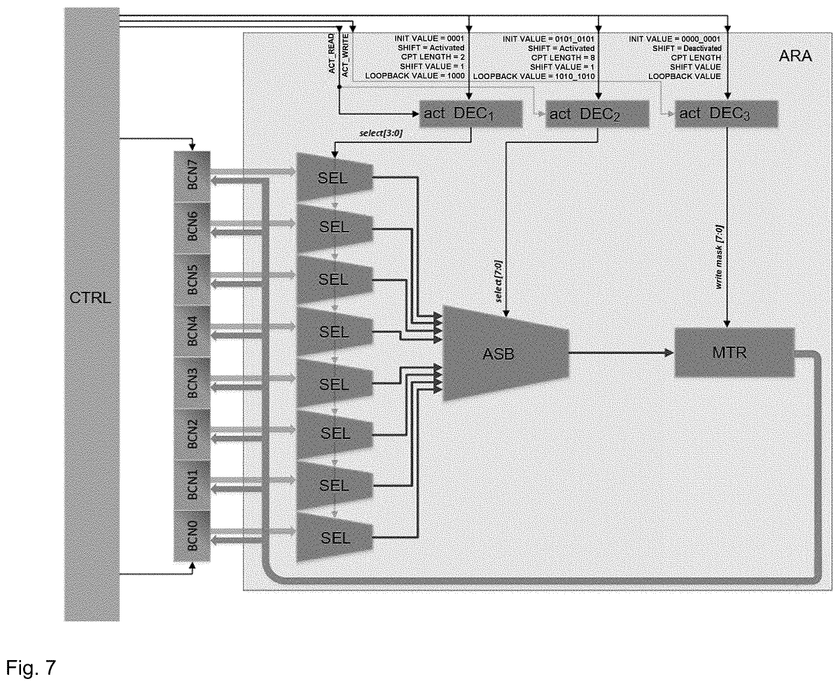

FIG. 7 illustrates the configuration of the automatic routing module ARA for rearranging data as shown in FIG. 6b.

The control signal for the selectors SEL that is generated by the first control unit DEC₁ is a 4-bit signal that allows selection of the 4 8-bit data items originating from the computing blocks BCN and that are present in the input buffers. For example, the bits in the control signal set to 1 indicate the index of the data to be selected in the input buffer.

The control signal of the assembler ASB generated by the second control unit DEC₂ is an 8-bit signal that allows the outputs of the 8 selectors SEL to be selected. For example, the bits in this control signal set to 1 indicate the index of the selectors to be selected.

The control signal of the multi-transfer module MTR is an 8-bit signal that corresponds to a write mask indicating the parallel routing of the output of the module to the 8 output buffers corresponding to the 8 computing blocks BCN. For example, the bits in this control signal set to 1 indicate the index of the output buffers to which the data is transferred.

The configuration of the control and automatic shift units is as follows.

### Unit DEC₁

Initial value: 0001
Shift: activated
Counter length: 2
Shift value: 1
Loopback value: 1,000

### Unit DEC₂

Initial value: 0101_0101
Shift: activated
Counter length: 8
Shift value: 1
Loopback value: 1010_1010

### Unit DEC₃

Initial value: 0000_0001
Shift: activated
Counter length: NA
Shift value: NA
Loopback value: NA

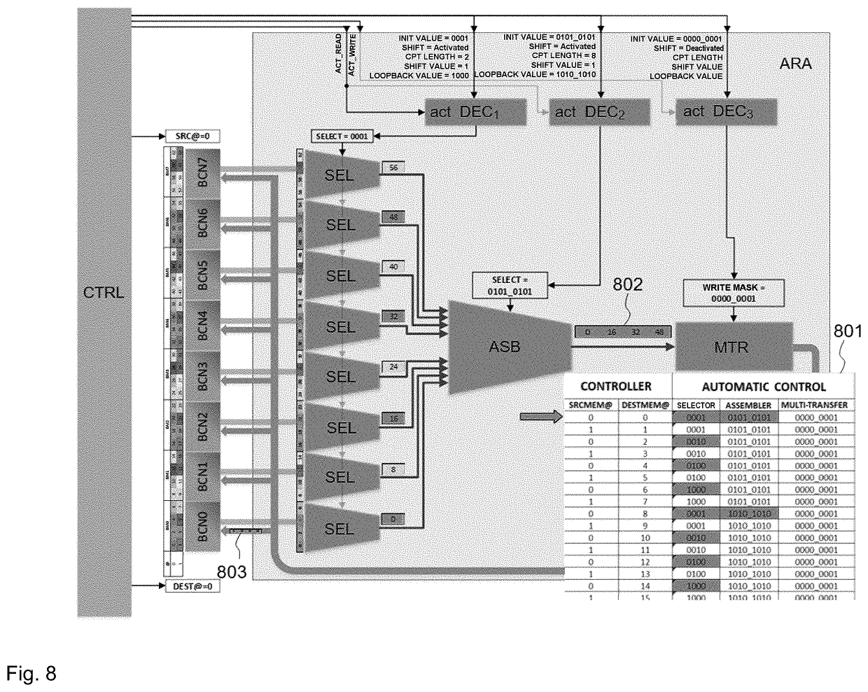

FIGS. 8 to 11 illustrate the generation of the first four output buffers of the automatic routing module.

FIG. 8 illustrates the generation of the first output buffer.

Table 801 provides the sequence of values of the three control signals (in the “SELECTOR”, “ASSEMBLER” and “MULTI-TRANSFER” columns, respectively) for placing the 64 pixels in a memory, along with the addresses of the source memories SRCMEM@ and the addresses of the destination memories DESTMEM@. These two read and write addresses are directly managed by the global controller by implementing an address generator. For example, French patent FR 2202150 filed by the Applicant describes an address generator for an SIMD computing architecture that can be used in this context.

The operation of rearranging data in the destination memories is performed in 16 cycles as described in the 16 rows of Table 801 below.

| | | AUTOMATIC CONTROL | | |
|---|---|---|---|---|
| CONTROLLER | | | ASSEM- | MULTI- |
| SRCMEM@ | DESTMEM@ | SELECTOR | BLER | TRANSFER |
| 0 | 0 | 0001 | 0101_0101 | 0000_0001 |
| 1 | 1 | 0001 | 0101_0101 | 0000_0001 |
| 0 | 2 | 0010 | 0101_0101 | 0000_0001 |
| 1 | 3 | 0010 | 0101_0101 | 0000_0001 |
| 0 | 4 | 0100 | 0101_0101 | 0000_0001 |
| 1 | 5 | 0100 | 0101_0101 | 0000_0001 |
| 0 | 6 | 1000 | 0101_0101 | 0000_0001 |
| 1 | 7 | 1000 | 0101_0101 | 0000_0001 |
| 0 | 8 | 0001 | 1010_1010 | 0000_0001 |
| 1 | 9 | 0001 | 1010_1010 | 0000_0001 |
| 0 | 10 | 0010 | 1010_1010 | 0000_0001 |
| 1 | 11 | 0010 | 1010_1010 | 0000_0001 |
| 0 | 12 | 0100 | 1010_1010 | 0000_0001 |
| 1 | 13 | 0100 | 1010_1010 | 0000_0001 |
| 0 | 14 | 1000 | 1010_1010 | 0000_0001 |
| 1 | 15 | 1000 | 1010_1010 | 0000_0001 |

FIG. 8 more specifically illustrates the first cycle.

For this first cycle, each input buffer contains the 32-bit value read at the address SRCMEM@=0 of each source memory of each computing block BCN. The selector control signal is 0001, thus the first data item in each input buffer is selected. This corresponds to the pixels with respective indices 0, 8, 16, 24, 32, 40, 48 and 56.

The assembler ASB is controlled by a selection signal that is 0101_0101, thus the outputs of selectors with indices 0, 2, 4 and 6 are read and consolidated in the intermediate buffer 802, which contains the pixels with indices 0, 16, 32 and 48 concatenated in a 32-bit word.

Finally, the multi-transfer module MTR is controlled by a write mask equal to 0000_0001, which involves switching the intermediate buffer 802 to the first output buffer 803 corresponding to the first computing block BCN0.

This 32-bit word is then written to the destination memory of the computing block BCN0 at the destination address DESTMEM@=0.

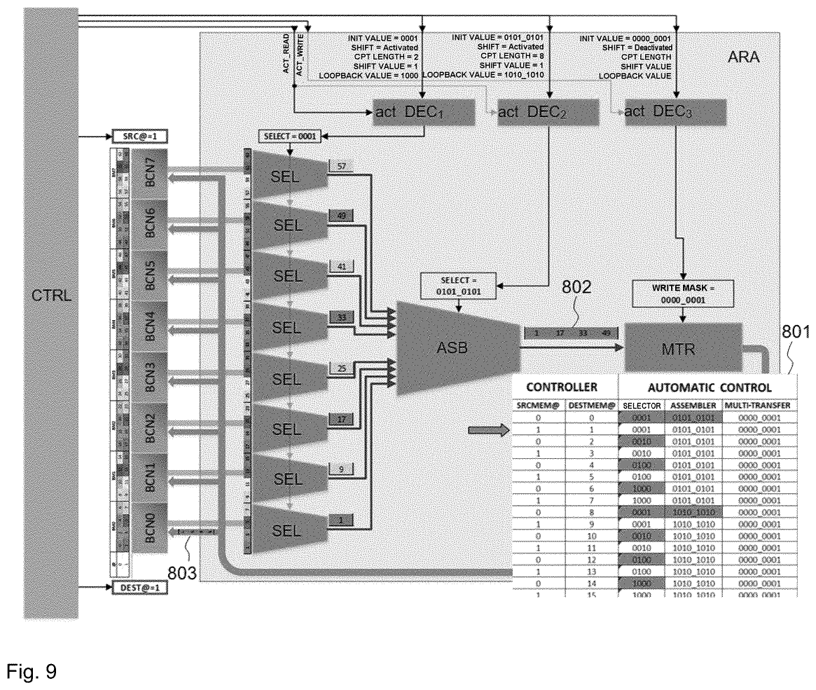

FIG. 9 illustrates the execution of the second cycle of the sequence. The input data is read at the source address SRCMEM@=1 of each source memory of each computing block.

The selector control signal is always 0001, thus the first data item in each input buffer is selected. This corresponds to the pixels with respective indices 1, 9, 17, 25, 33, 41, 49 and 57.

The assembler ASB is controlled by a selection signal that is 0101_0101, thus the outputs of selectors with indices 0, 2, 4 and 6 are read and consolidated in the intermediate buffer 802, which contains the pixels with indices 1, 17, 33 and 49 concatenated in a 32-bit word.

Finally, the multi-transfer module MTR is controlled by a write mask equal to 0000_0001, which involves switching the intermediate buffer 802 to the first output buffer 803 corresponding to the first computing block BCN0.

This 32-bit word is then written to the destination memory of the computing block BCN0 at the destination address DESTMEM@=1.

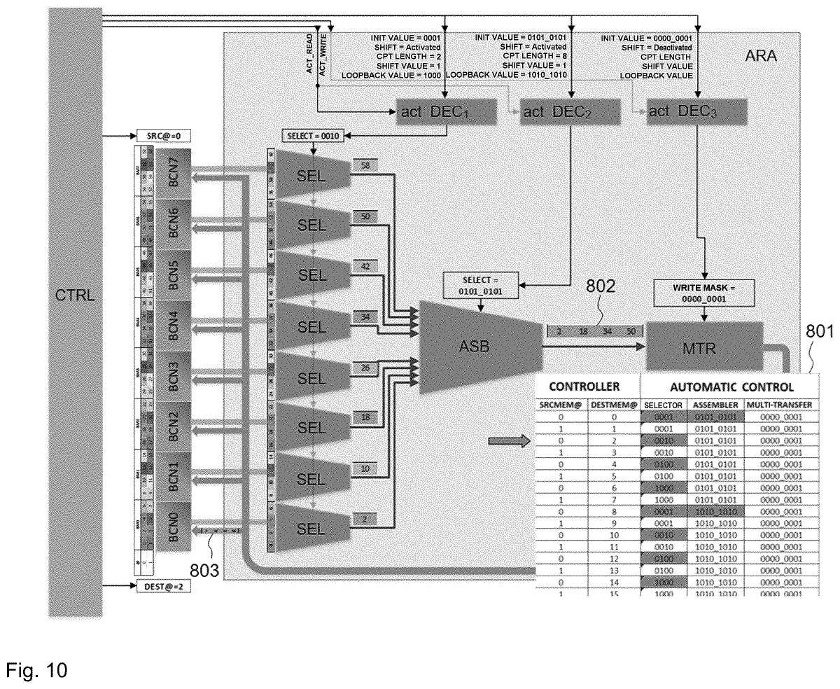

FIG. 10 illustrates the execution of the third cycle of the sequence. The input data is read at the source address SRCMEM@=0 of each source memory of each computing block.

The selector control signal is 0010, thus the second data item in each input buffer is selected. This corresponds to the pixels with respective indices 2, 10, 18, 26, 34, 42, 50 and 58.

The assembler ASB is controlled by a selection signal that is 0101_0101, thus the outputs of selectors with indices 0, 2, 4 and 6 are read and consolidated in the intermediate buffer 802, which contains the pixels with indices 2, 18, 34 and 50 concatenated in a 32-bit word.

Finally, the multi-transfer module MTR is controlled by a write mask equal to 0000_0001, which involves switching the intermediate buffer 802 to the first output buffer 803 corresponding to the first computing block BCN0.

This 32-bit word is then written to the destination memory of the computing block BCN0 at the destination address DESTMEM@=2.

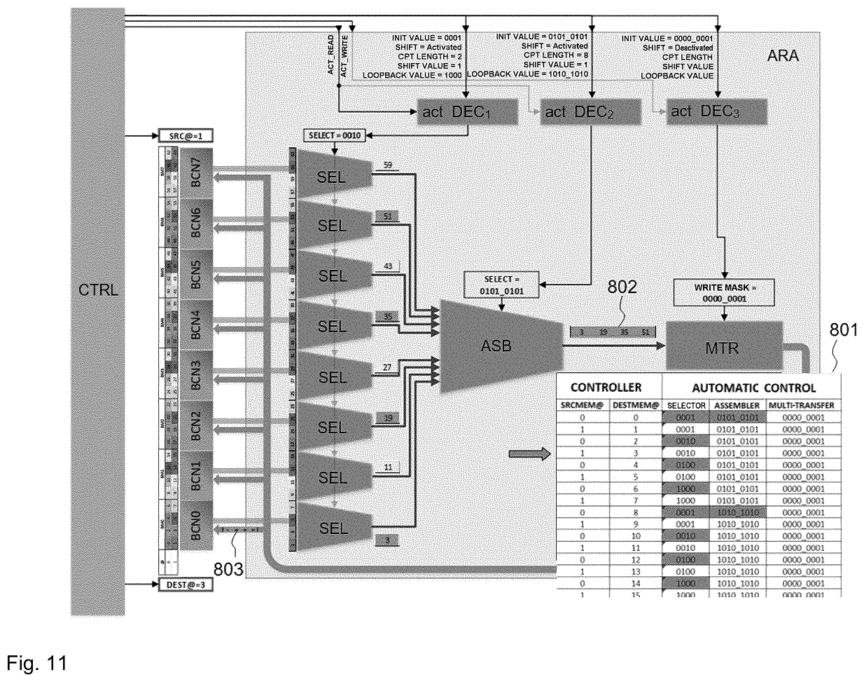

FIG. 11 illustrates the execution of the fourth cycle of the sequence. The input data is read at the source address SRCMEM@=1 of each source memory of each computing block.

The selector control signal is 0010, thus the second data item of each input buffer is selected. This corresponds to the pixels with respective indices 3, 11, 19, 27, 35, 43, 51, and 59.

The assembler ASB is controlled by a selection signal that is 0101_0101, thus the outputs of selectors with indices 0, 2, 4 and 6 are read and consolidated in the intermediate buffer 802, which contains the pixels with indices 3, 19, 35 and 51 concatenated in a 32-bit word.

Finally, the multi-transfer module MTR is controlled by a write mask equal to 0000_0001, which involves switching the intermediate buffer 802 to the first output buffer 803 corresponding to the first computing block BCN0.

This 32-bit word is then written to the destination memory of the computing block BCN0 at the destination address DESTMEM@=3.

The sequence continues with the following cycles illustrated in Table 801 until the destination memory location is reached with 16-step data interleaving.

Table 801 shows the operation of the shifts applied to the selector and assembler control signals, as well as the write mask that controls the multi-transfer module implemented by the control and shift units as described in FIG. 5.

In this example, the selector control signal (unit DEC₁) is set to the value 0001. This value is shifted by 1 bit every 2 cycles since the counter length is equal to 2. This value is reset to the initial value 0001 when the signal value reaches the loopback value 1000.

The assembler control signal (unit DEC₂) is set to the value 0101_0101. This value is shifted by 1 bit every 8 cycles since the counter length is equal to 8. This value is reset to the initial value after reaching the loopback value 1010_1010.

The control signal for the multi-transfer module (unit DEC₃) is set to the value 0000_0001 and remains constant since the shift is deactivated for this unit.

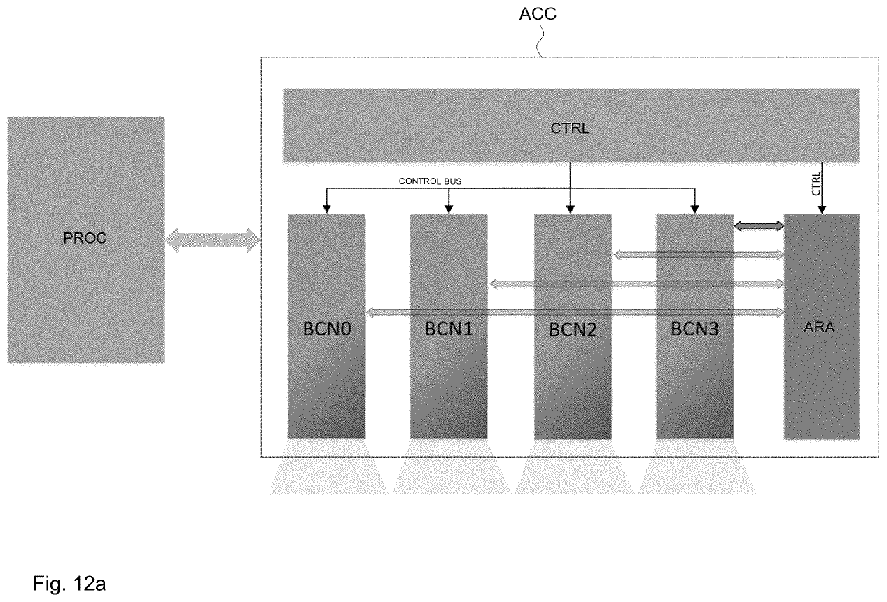

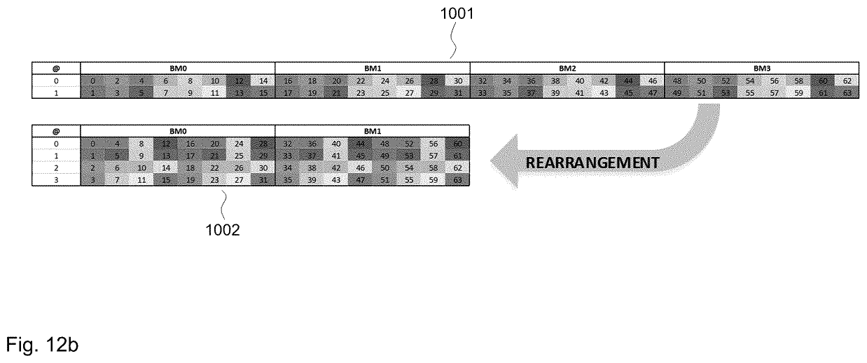

FIGS. 12a to 15 illustrate another example of the application of the automatic routing module according to the invention.

In the example of FIG. 12a, the hardware accelerator ACC comprises four computing blocks BCN. The memories of the computing blocks, as well as the input and output buffers of the routing module ARA, are 32-bit memories so as to encapsulate 8 data items encoded on 4 bits each. FIG. 12b shows the location of the data in a memory for this example.

In the example in FIG. 12b, the data is located in the source memories 1001 according to 2-pixel interleaving.

The routing module ARA is configured to locate the data in destination memories 1002 according to 4-pixel interleaving.

In the example in FIG. 12b, a set of 64 pixels is thus distributed in the 4 source memories of the 4 computing blocks BCN. The rearrangement of the data involves distributing these 64 pixels into two destination memories of the first two computing blocks BCN0, BCN1 according to 4-pixel interleaving.

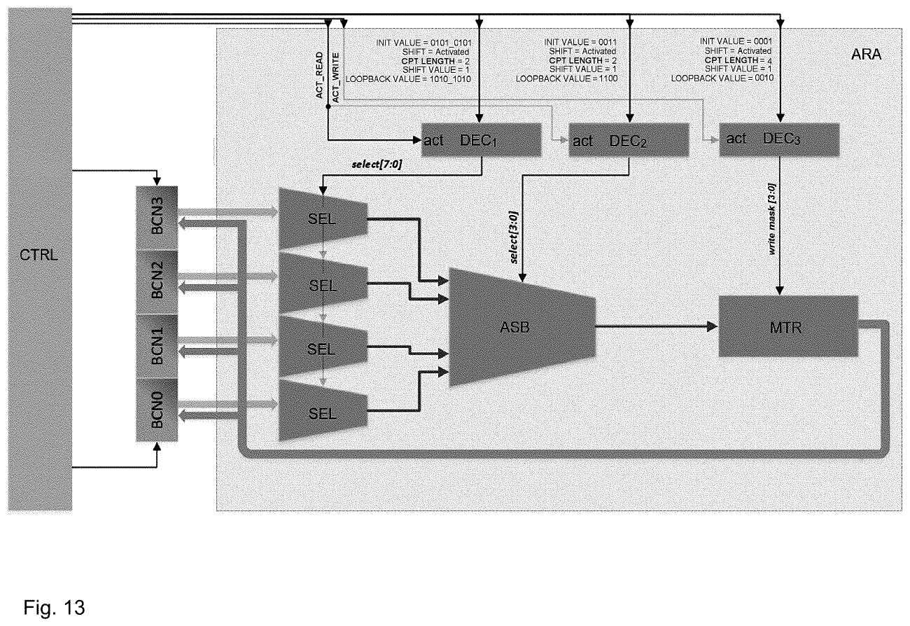

FIG. 13 illustrates the configuration of the automatic routing module ARA for rearranging the data shown in FIG. 12b.

The control signal for the selectors SEL that is generated by the first control unit DEC₁ is an 8-bit signal that selects the 8 4-bit data items that originated from the computing blocks BCN and are present in the input buffers.

The control signal for the assembler ASB that is generated by the second control unit DEC₂ is a 4-bit signal that allows the outputs of the 4 selectors SEL to be selected.

The control signal for the multi-transfer module MTR is a 4-bit signal that corresponds to a write mask indicating the parallel routing of the output of the module to the 4 output buffers corresponding to the 4 computing blocks BCN.

The configuration of the control and automatic shift units is as follows.

### Unit DEC₁

Initial value: 0101_0101
Shift: activated
Counter length: 2
Shift value: 1
Loopback value: 1010_1010

### Unit DEC₂

Initial value: 0011
Shift: activated
Counter length: 4
Shift value: 2
Loopback value: 1100

### Unit DEC₃

Initial value: 0001
Shift: activated
Counter length: 4
Shift value: 1
Loopback value: 0010

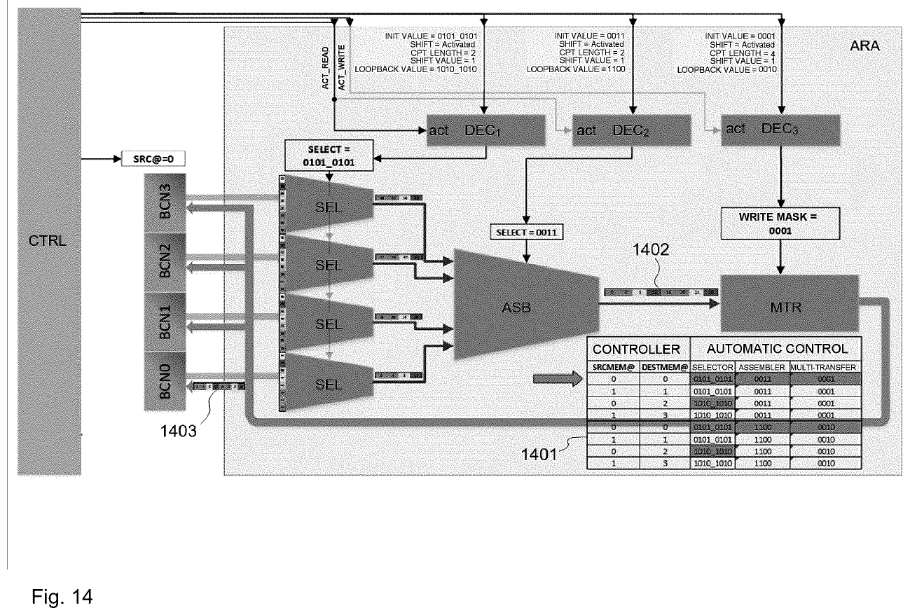

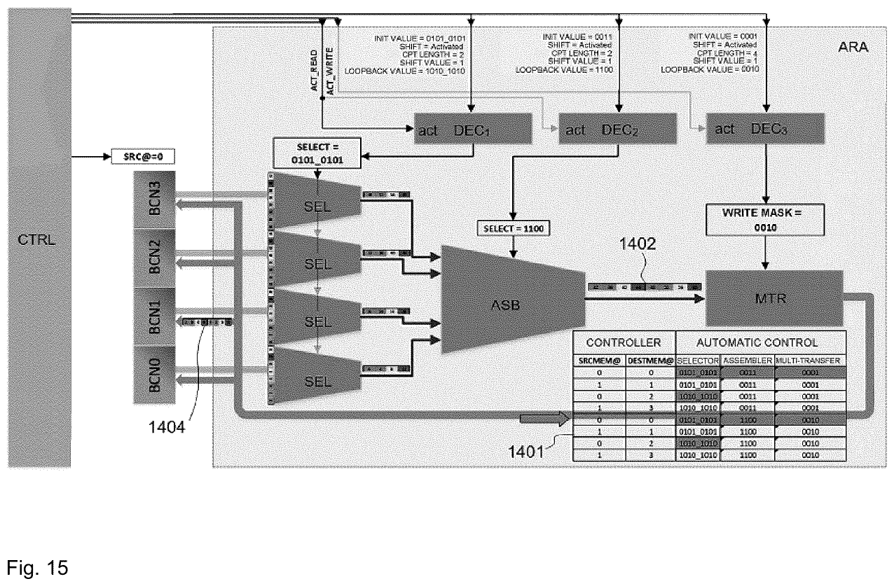

FIGS. 14 and 15 illustrate the generation of two output buffers from the automatic routing module.

FIG. 14 illustrates the generation of the first output buffer.

Table 1401 provides the sequence of values of the three control signals for locating 64 pixels in a memory, along with the addresses of the source memories SRCMEM@ and the addresses of the destination memories DESTMEM@. These two read and write addresses are directly managed by the global controller by implementing a multi-dimensional address generator.

The operation of rearranging data in the destination memories is performed in 8 cycles described in the 8 rows of Table 1401 listed below.

| | | AUTOMATIC CONTROL | | |
|---|---|---|---|---|
| CONTROLLER | | | ASSEM- | MULTI- |
| SRCMEM@ | DESTMEM@ | SELECTOR | BLER | TRANSFER |
| 0 | 0 | 0101_0101 | 0011 | 0001 |
| 1 | 1 | 0101_0101 | 0011 | 0001 |
| 0 | 2 | 1010_1010 | 0011 | 0001 |
| 1 | 3 | 1010_1010 | 0011 | 0001 |
| 0 | 0 | 0101_0101 | 1100 | 0010 |
| 1 | 1 | 0101_0101 | 1100 | 0010 |
| 0 | 2 | 1010_1010 | 1100 | 0010 |
| 1 | 3 | 1010_1010 | 1100 | 0010 |

For the first cycle, each input buffer contains the 32-bit value read at the address SRCMEM@=0 of each source memory of each computing block BCN. The selector control signal is 0101_0101, thus one in two data items is read in each input buffer, as shown at the outputs of the selectors SEL.

The assembler ASB is controlled by a selection signal that is 0011, thus the outputs of selectors with indices 0 and 1 are read and consolidated in the intermediate buffer 1402, which contains the pixels with indices 0, 4, 8, 12, 16, 20, 24 and 28 concatenated into a 32-bit word.

Finally, the multi-transfer module MTR is controlled by a write mask equal to 0001, which involves switching the intermediate buffer 1402 to the first output buffer 1403 corresponding to the first computing block BCN0.

This 32-bit word is then written to the destination memory of the computing block BCN0 at the destination address DESTMEM@=0.

FIG. 15 illustrates the generation of the fifth output buffer corresponding to the fifth cycle of sequence 1401.

For the fifth cycle, each input buffer contains the 32-bit value read at the address SRCMEM@=0 of each source memory of each computing block BCN. The selector control signal is 0101_0101, thus one in two data items is read in each input buffer as shown at the outputs of the selectors SEL.

The assembler ASB is controlled by a selection signal that is 1100, thus the outputs of selectors with indices 2 and 3 are read and consolidated in the intermediate buffer 1402, which contains the pixels with indices 32, 36, 40, 44, 48, 52, 56, and 60 concatenated in a 32-bit word.

Finally, the multi-transfer module MTR is controlled by a write mask equal to 0010, which involves switching the intermediate buffer 1402 to the second output buffer 1404 corresponding to the second computing block BCN1.

This 32-bit word is then written to the destination memory of the computing block BCN0 at the destination address DESTMEM@=0.

The other operating cycles of the routing module ARA are performed in accordance with the control signals described in Table 1401.

Table 1401 shows the operation of the shifts applied to the selector and assembler control signals and the write mask that controls the multi-transfer module implemented by the control and shift units as described in FIG. 5.

In this example, the selector control signal (unit DEC₁) is set to the value 0101_0101. This value is shifted by 1 bit every 2 cycles since the counter length is equal to 2. This value is reset to the initial value after the signal value reaches the loopback value 1010_1010.

The assembler control signal (unit DEC₂) is set to the value 0011. This value is shifted by a value of 2 bits every 4 cycles since the counter length is equal to 4. This value is reset to the initial value after reaching the loopback value 1100.

The control signal for the multi-transfer module (unit DEC₃) is set to the value 0011. This value is shifted by a value of 1 bit every 4 cycles since the length of the counter is equal to 4. This value is reset to the initial value after reaching the loopback value 0010.

In general, the automatic routing module ARA according to the invention can be configured to perform different data rearrangement functions. In particular, it can be configured, via the configuration signals of the control and shift units, to perform any rearrangement of a memory location according to a first interleaving level to a memory location according to a second, different interleaving level. The size of the input buffers and the size of the data also can be configured. The module can be adapted to different numbers of computing blocks by modifying the number of inputs/outputs and selectors.

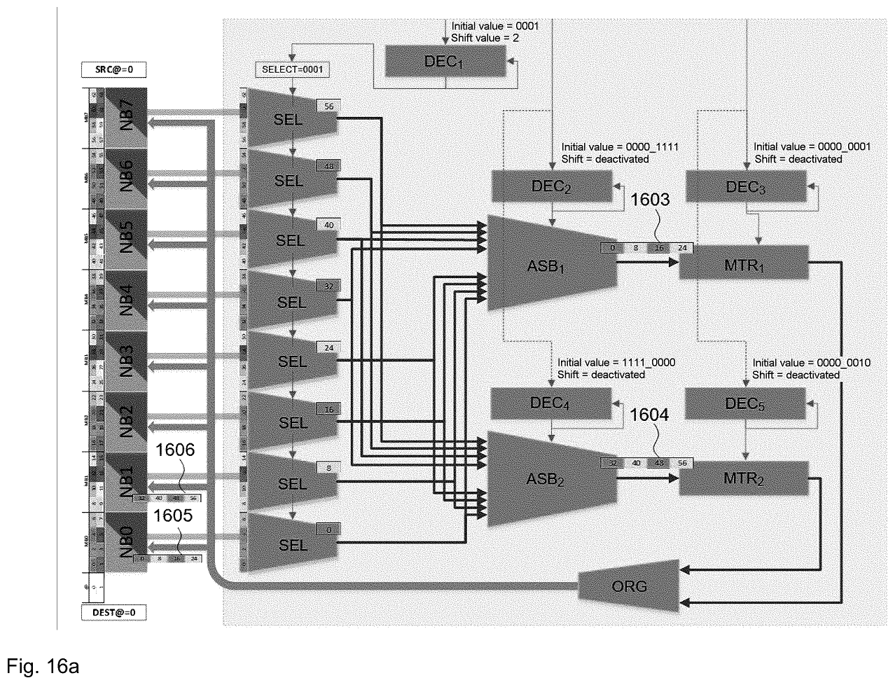

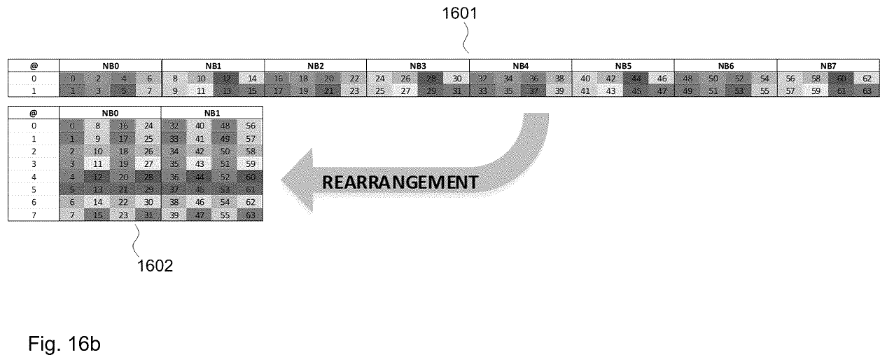

FIGS. 16a and 16b show another embodiment of the automatic routing module according to the invention comprising a plurality of assemblers ASB1, ASB2 and a plurality of multi-transfer modules MTR1, MTR2.

In this embodiment, a decision-making unit ORG is connected to the outputs of the multi-transfer modules in order to implement a priority management mechanism for switching the output buffers of these modules to the output buffers of the routing module.

Each assembler and each multi-transfer module is associated with a control and shift unit. Thus, in the example of FIG. 16a, the routing module ARA comprises 5 units DEC₁, DEC₂, DEC₃, DEC₄, DEC₅.

Such an embodiment has the advantage of increasing the parallelism of the processing operations.

The embodiment shown in FIG. 16a can be configured to perform the same types of routing or rearrangement of data in a memory as described above.

For example, it can rearrange data from a source memory data location with 2-step interleaving to a destination memory data location with 8-step interleaving, as illustrated in FIG. 16b by the source 1601 and destination 1602 memory tables. The data is encoded on 8 bits and the buffers are 32-bit buffers. The number of computing blocks is equal to 8.

FIG. 16a shows the first operating cycle of the routing module ARA.

The configuration of the control and automatic shift units is as follows.

### Unit DEC₁

Initial value: 0001
Shift: activated
Counter length: 2
Shift value: 1
Loopback value: 1000

### Unit DEC₂

Initial value: 0000_1111
Shift: deactivated
Counter length: NA
Shift value: NA
Loopback value: NA

### Unit DEC₃

Initial value: 0000_0001
Shift: deactivated
Counter length: NA
Shift value: NA
Loopback value: NA

### Unit DEC₄

Initial value: 1111_0000
Shift: deactivated
Counter length: NA
Shift value: NA
Loopback value: NA

### Unit DEC₅

Initial value: 0000_0010
Shift: deactivated
Counter length: NA
Shift value: NA
Loopback value: NA

For this first cycle, each input buffer contains the 32-bit value read at the address SRCMEM@=0 of each source memory of each computing block BCN. The selector control signal is 0001, thus the first data item in each input buffer is selected. This corresponds to the pixels with respective indices 0, 8, 16, 24, 32, 40, 48 and 56.

The first assembler ASB₁ is controlled by a selection signal that is 0000_1111, thus the outputs of selectors with indices 0, 1, 2, 3 are read and consolidated in the intermediate buffer 1603, which contains the pixels with indices 0, 8, 16, 24 concatenated in a 32-bit word.

The second assembler ASB₂ is controlled by a selection signal that is 1111_0000, so that the outputs of selectors with indices 4, 5, 6, and 7 are read and consolidated in the intermediate buffer 1604, which contains the pixels with indices 32, 40, 48, 56 concatenated in a 32-bit word.

The first multi-transfer module MTR₁ is controlled by a write mask equal to 0000_0001, which involves switching the intermediate buffer 1603 to the first output buffer 1605 corresponding to the first computing block BCN0.

The second multi-transfer module MTR₂ is controlled by a write mask equal to 0000_0010, which involves switching the intermediate buffer 1604 to the second output buffer 1606 corresponding to the second computing block BCN1.

The decision-making unit ORG implements a priority rule which, for example, provides the write priority to the first multi-transfer module MTR₁ in the event of a write conflict between the multi-transfer modules MTR₁ and MTR₂.

The invention can be implemented using hardware and/or software elements.

In particular, the automatic routing module according to the invention can be implemented in a hardware accelerator produced using one or more elements from among an embedded processor or a specific device. The processor can be a generic processor, a specific processor, an application-specific integrated circuit (also known as an ASIC) or a field-programmable gate array (also known as an FPGA). The device according to the invention can use one or more dedicated electronic circuits or a general-purpose circuit. The technique of the invention can be implemented on a reprogrammable computing machine (for example, a processor or a microcontroller) executing a program comprising a sequence of instructions, or on a dedicated computing machine (for example, a set of logic gates such as an FPGA or ASIC, or any other hardware module).

1. An automatic data routing module (ARA) for a “single instruction, multiple data” architecture computer comprising a plurality of elementary processors each associated with a local memory, the routing module comprising:
an input interface comprising a plurality of input buffers, each intended to receive data read from a respective local memory;
an output interface comprising a plurality of output buffers, each intended to transmit data to be written to a respective local memory;
a selector (SEL), for each input buffer, configured to select one or more data items contained in the input buffer;
at least one assembler (ASB) configured to consolidate the data selected by at least two selectors (SEL) into an assembly buffer;
a transfer module (MTR) for each assembler, configured to transfer the data from the assembly buffer of said assembler to at least one output buffer for writing said data to at least one local memory.

2. The automatic data routing module according to claim 1, further comprising a control unit comprising at least three identical controllers (DEC₁, DEC₂, DEC₃) respectively configured to control all the selectors (SEL), an assembler (ASB) and a transfer module (MTR), each controller being configured to generate a control signal based on a set of specific configuration signals.

3. The automatic data routing module according to claim 2, wherein a controller (DEC₁, DEC₂, DEC₃) comprises at least one counter (CPT) and a shift unit configured, based on the set of configuration signals, to generate a control signal.

4. The automatic data routing module according to claim 3, wherein the set of configuration signals comprises: an initial value of the control signal, a counting length value, a loopback value and a shift value, the value of the control signal being shifted by the shift value when the counter reaches the counting length value, the value of the control signal being reset to its initial value when it reaches the loopback value.

5. The automatic data routing module according to claim 3, wherein the set of configuration signals includes a shift activation value for activating or deactivating the shift of the control signal.

6. The automatic data routing module according to claim 5, wherein the shift of the control signal of the transfer module (MTR) is deactivated.

7. The automatic data routing module according to claim 2, wherein the control signal of the set of selectors is configured to notify each selector of which data to select from the input buffer from among a plurality of concatenated data.

8. The automatic data routing module according to claim 2, wherein the control signal of the assembler is configured to notify the assembler of which selectors to select as inputs.

9. The automatic data routing module according to claim 2, wherein the control signal of the transfer module is configured to notify the transfer module of the output buffer to which the data from the assembly buffer is to be transferred.

10. The automatic data routing module according to claim 2, wherein the values of the configuration signals are defined such that the routing module is configured to receive data read from the local memories in interleaved form according to a first interleaving configuration, the input buffers being designed to receive a concatenation of a plurality of data from a row in a local memory.

11. The automatic data routing module according to claim 10, wherein the values of the configuration signals are defined such that the routing module is configured to supply, in the output buffers, data intended to be written to the local memories in interleaved form according to a second interleaving configuration different from the first interleaving configuration.

12. The automatic data routing module according to claim 1, comprising a plurality of assemblers (ASB₁, ASB₂) and a plurality of transfer modules (MTR₁, MTR₂) and a decision-making unit (ORG) for managing the transfer priorities of the outputs of the transfer modules to the output buffers.

13. A “Single instruction, multiple data” architecture computer comprising a host processor (PROC) and a hardware accelerator (ACC) comprising a plurality of computing blocks (BCN), each computing block (BCN) comprising a local memory (BMEM) and at least one elementary processor (PE), a global controller (CTRL) and an automatic data routing module (ARA) according to claim 1 configured to modify the location of data in the local memories according to a location instruction generated by the global controller, the global controller being configured to define the configuration signals of the control unit of the automatic routing module based on the location instruction.

14. A Computer according to claim 13, further comprising an address generator configured to generate a read address in the local memories for reading the data to be transferred to the automatic routing module and a write address in the local memories for writing the data supplied by the automatic routing module.
